(19) United States
(12) Patent Application Publication
(10) Pub. No.: US 2018/0290351 A1
(43) Pub. Date: Oct. 11, 2018

(54) DEVICE AND PROCESS FOR PRODUCING MOLDINGS COMPOSED OF A PARTICLE FOAM

(71) Applicant: KRALLMANN KUNSTSTOFFVERARBEITUNG GMBH, Hiddenhausen (DE)

(72) Inventor: Ingo BREXELER, Wetter/Ruhr (DE)

(21) Appl. No.: 15/767,815

(22) PCT Filed: Sep. 27, 2016
(86) PCT No.: PCT/EP2016/001602

§ 371 Date: Apr. 12, 2018

(30) Foreign Application Priority Data
Oct. 13, 2015 (DE) 10 2015 013 131.1

(51) Int. Cl. B29C 44/58; B29C 44/34; B29C 44/44; B29C 44/60

(52) U.S. Cl. CPC B29C 44/58; B29C 44/60; B29C 44/445; B29C 44/3426

(57) ABSTRACT

A device (10) for producing moldings composed of a moldable foam has a multiplicity of sub-molds (11, 12) which in each case have a sub-cavity (14). The sub-cavities (14) act together to form a molding cavity (K). At least one of the sub-molds (11, 12) has a feed channel (35) through which plastics beads can be introduced into the molding cavity (K), and a steam chamber (24) from which superheated steam can be introduced through at least one steam channel (18) into the molding cavity (K). The at least one sub-mold (11, 12) has a first mold segment in which the sub-cavity (14) is present and a second mold segment in which the steam chamber (24) is present. The first mold segment has a first temperature-control system (15), and the second mold segment has a second temperature-control system (20).

### CROSS REFERENCE TO RELATED APPLICATIONS

This application is a United States National Phase Application of International Application PCT/EP2016/001602, filed Sep. 27, 2016, and claims the benefit of priority under 35 U.S.C. § 119 of German Application DE 10 2015 013 131.1, filed Oct. 13, 2015, the entire contents of which are incorporated herein by reference.

### FIELD OF THE INVENTION

The invention relates to a device for producing moldings composed of a particle foam, with a plurality of sub-molds, which have a sub-cavity each, wherein the sub-cavities interact to form a molding cavity, wherein at least one of the sub-molds has a feed channel, through which plastic particles can be introduced into the molding cavity, and a steam chamber, from which a superheated steam can be introduced into the molding cavity through at least one steam channel.

The present invention relates, moreover, to a process for producing moldings composed of a particle foam, wherein the plastic particles are introduced into the molding cavity and are foamed and/or sintered there while feeding superheated steam.

### BACKGROUND OF THE INVENTION

A device for producing moldings or components, which consist of a particle foam, usually has two sub-molds, which have a sub-cavity each and can be brought together and moved apart from one another. In the brought-together state, the sub-cavities form a molding cavity, into which the plastic particles, consisting, for example, of EPP (expanded polypropylene) or EPS (expanded polystyrene) can be introduced. A steam chamber each, which is supplied with superheated steam by one or more steam generators, is formed in the sub-molds. The superheated steam can be introduced into the molding cavity from the steam chambers via steam nozzles, which leads to the welding or sintering of the foam particles previously introduced into the molding cavity.

The fed superheated steam heats in the process not only the foam particles present in the molding cavity to the temperature necessary for the welding or sintering (approx. 160° C. in the case of EPP and approx. 120° C. in the case of EPS), but it also heats at the same time the sub-molds, the wall of the molding cavity and also the wall of the steam chamber.

After the welding or sintering of the foam particles has taken place in the molding cavity, the sub-molds and hence also the steam chamber are cooled with a cooling fluid, usually cold water, to a temperature of approx. 80° C., after which the sub-molds are moved apart, so that the molding can be removed from the mold.

The process of heating the molding cavity, the sub-molds and the steam chamber by means of superheated steam and the subsequent cooling of the molding cavity, of the sub-molds and of the steam chamber with cooling water usually take place periodically. This leads to a high energy and superheated steam demand, because not only is the energy necessary for welding or sintering fed to the plastic particles by means of the superheated steam, but the essential portion of the superheated steam heats the surrounding components, i.e., the molding cavity, the sub-molds and the steam chamber, which must subsequently be cooled again and then heated again by new superheated steam. This leads, on the whole, to a high energy demand, as a result of which the prior-art processes are very costly.

### SUMMARY OF THE INVENTION

A basic object of the present invention is to provide a device for producing moldings composed of a particle foam, in which the energy demand is markedly reduced.

Further, a process for manufacturing moldings composed of particle foam shall be provided, which can be carried out with reduced energy demand rapidly and in a simple manner.

This object is accomplished from the viewpoint of device technology by a device having the features of the present invention. Provisions are made here for the at least one sub-mold to comprise a first mold segment having the sub-cavity and a second mold segment having the steam chamber, wherein the first mold segment has a first temperature control system, by means of which the first mold segment can be heated and/or cooled to a predetermined temperature, and wherein the second mold segment has a second temperature control system, by means of which the second mold segment can be heated and/or cooled to a predetermined temperature.

The present invention is based on the basic consideration of introducing the energy that is necessary for welding, sintering and optionally also foaming the plastic particles in the molding cavity exclusively or at least predominantly in the known manner by means of the superheated steam, but of separating the energy that is necessary for the periodical heating and cooling of the molding cavity and of the steam chamber from the energy system of the superheated steam. Each sub-mold is divided for this into a plurality of mold segments, whose temperature is controlled, i.e., which can be heated and/or cooled, separately from one another.

To solidify the molding formed from the particle foam within the molding cavity, it is necessary to cool the wall of the molding cavity and hence the molding after the welding or sintering. This is carried out by means of the first temperature control system, with which the first mold segment, in which the sub-cavity of the molding cavity is formed, can be heated and/or cooled to a desired temperature. In addition to this, the second mold segment is provided, which comprises the steam chamber. The steam chamber does not have to be cooled to solidify the molding present in the molding cavity, so that the second temperature control system of the second mold segment can be used to maintain the steam chamber and hence the second mold segment at a predetermined temperature. The components or compounds, which must be heated and cooled in each cycle of the process, are markedly reduced in this manner, and the amount of superheated steam necessary for forming the molding is additionally reduced, because the superheated steam must essentially only introduce the energy necessary for foaming, welding or sintering the plastic particles.

Provisions are made in a preferred embodiment of the present invention for the device to comprise at least two sub-molds and especially exactly two sub-molds, which have each the first mold segment and the second mold segment having each the mentioned configuration.

Provisions may be made in a preferred embodiment of the present invention for the first mold segment and the second mold segment to be separated from each other and/or maintained at spaced locations from one another by a heat-insulating layer. The heat-insulating layer between the first mold segment and the second mold segment ensures that the heat transfer between these two mold segments can be reduced. It can be achieved in this manner that the second mold segment will not be needlessly cooled as well during the cooling of the first mold segment. In addition or as an alternative to the heat-insulating layer between the first mold segment and the second mold segment, an air gap, which has an insulating effect, may be formed between these two mold segments.

Provisions are preferably made for the first temperature control system of the first mold segment to have at least one fluid channel, which is formed in the first mold segment and through which a temperature control fluid can flow. The temperature control fluid may be a liquid or a gas. Hot water is usually used for heating and cold water for cooling.

Provisions may be made in a variant of the present invention for the first temperature control system to have at least one first temperature sensor, which is connected to a first temperature control device. A control circuit is formed in this manner, by means of which the temperature of the first mold segment can be set and monitored in a predetermined manner.

Provisions may be made in a variant of the present invention for the second temperature control system of the second mold segment to have at least one fluid channel, which is formed in the second mold segment and through which a temperature control fluid can flow. The second temperature control system may have here a least one second temperature sensor, which is connected to a second temperature control device. The temperature control fluid used in the second temperature control system is preferably likewise hot or cold water, and the second temperature control device ensures that the predetermined temperature of the second mold segment is set and monitored.

The plastic particles are fed to the molding cavity via a feed channel, and the plastic particles may already have been foamed or will be foamed only within the molding cavity. The feed channel for the plastic particles preferably comprises at least one first feed channel section formed in the first mold segment and at least one second feed channel section formed in the second mold segment.

The above-mentioned object is accomplished in terms of device technology by a process having the features of the present invention. Provisions are made in this connection for the second mold segment to be maintained by means of the second temperature control system at a temperature that corresponds at least to the temperature of the superheated steam; for the first mold segment to be brought prior to the feeding of the superheated steam by means of the first temperature control system to a temperature that corresponds at least to the temperature of the superheated steam; and for the first mold segment to be cooled after the foaming and/or the sintering of the plastic particles in the molding cavity to a mold release temperature by means of the first temperature control system.

Provisions may be made in this connection for the second mold segment to be maintained by means of the second temperature control system at a temperature that is at most 5° C. below the temperature of the superheated steam and preferably corresponds at least to the temperature of the superheated steam and is especially preferably above the temperature of the superheated steam by at least 3° C. and especially by at least 5° C.

The second mold segment having the steam chamber is preferably regulated during the process by means of the second temperature control system to a steam chamber wall temperature that is slightly (by 3° C. to 5° C.) above the temperature of the superheated steam. This temperature is maintained at least approximately at a constant value during the process. The condensation of the superheated steam during the entry thereof into the steam chamber is avoided in this manner and energy is supplied once again to the superheated steam before it enters the molding cavity.

The first mold segment, in which the sub-cavity and hence the wall of the molding cavity is formed, is regulated to alternating temperatures by means of the separate first temperature control system during the process, i.e., the first mold segment is brought, before the feeding of the superheated steam, to a temperature that corresponds to the temperature of the superheated steam or is slightly above this temperature by means of the first temperature control system. When the first mold segment has reached the desired temperature level of the superheated steam, the plastic particles are filled into the molding cavity via the feed channel. After complete filling of the molding cavity, the superheated steam is introduced from the steam generator into the steam chamber preferably via insulated steam tubes and it is introduced from this into the molding cavity via steam nozzles. Condensation of the superheated steam can be prevented by the preheated and insulated mold segments, and the superheated steam reaches the molding cavity, where it welds, sinters and optionally previously foams the plastic particles, at a high temperature.

After welding or sintering of the foamed plastic particles has taken place in the molding cavity, the feeding of the superheated steam is interrupted, and the first mold segment and hence also the molding located in the molding cavity are cooled by means of the first temperature control system to a mold release temperature of, for example, approx. 80° C. After reaching the mold release temperature, the device is opened and the stabilized molding can be removed. The device then closes again and the process described takes place again in the above-described cycle.

The device for producing moldings composed of a particle foam comprises at least two sub-molds, at least one sub-mold of which and preferably both sub-molds has/have the first mold segment mentioned and the second mold segment mentioned and the temperatures thereof are controlled by means of the mentioned process and the corresponding temperature control systems.

The invention is hereinafter described by way of example and by way of the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a device for producing moldings composed of a particle foam in an opened state;

FIG. 2 is a schematic view of the device according to FIG. 1 in a closed state during the introduction of the plastic particles;

FIG. 3 is a schematic view of the device according to FIG. 2 during the feeding of the superheated steam; and

FIG. 4 is a schematic view of the device according to FIG. 3 with the formed molding.

### DESCRIPTION OF THE PREFERRED EMBODIMENTS

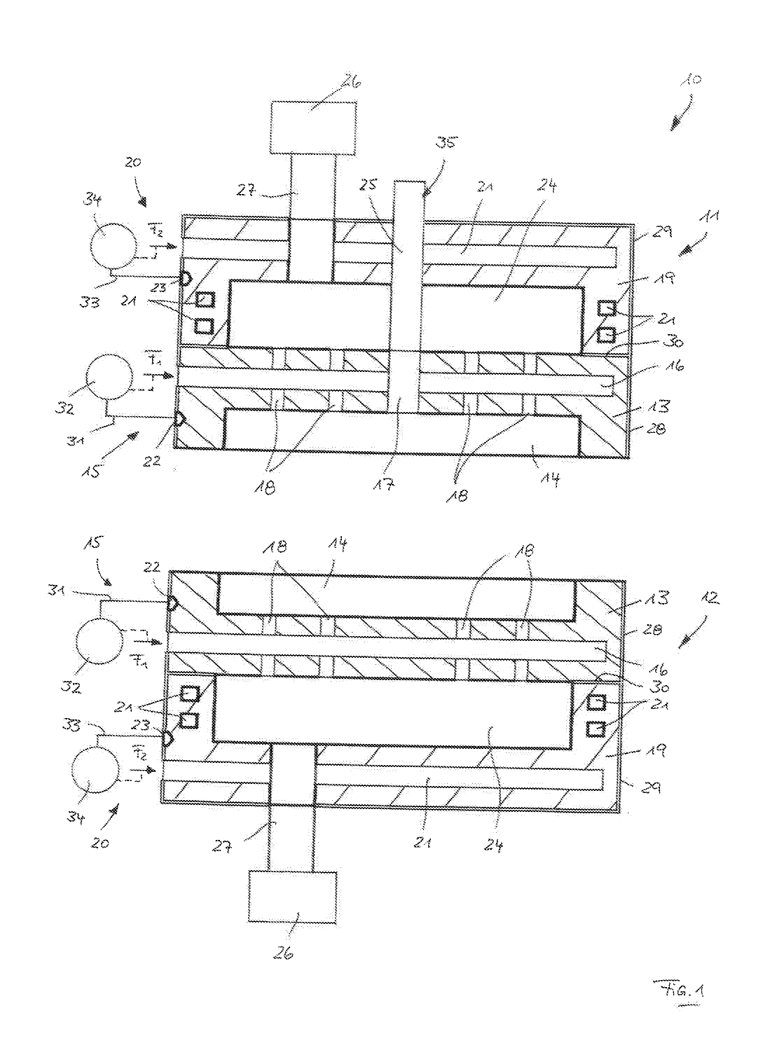

Referring to the drawings, FIG. 1 shows a device 10 for producing moldings composed of a particle foam, which has an upper, first sub-mold 11 and a lower, second sub-mold 12. The first sub-mold 11 has a lower, first mold segment 13, on the underside of which a sub-cavity 14 is formed. A first temperature control system 15, which comprises a fluid channel 16, which is formed in the first mold segment and through which a temperature control fluid, for example, hot or cold water, can flow, as is indicated by the arrow F₁, is associated with the first mold segment 13. A first temperature sensor 22, which detects the temperature of the first mold segment 13 and sends a corresponding temperature signal via a line 31 to a first control device 32, which can influence the supply of the temperature control fluid, as this is indicated by broken line, is arranged in the first mold segment 13. The first mold segment 13 can be brought to a desired temperature and maintained at this temperature with high accuracy by means of the first temperature control system.

The first mold segment 13 is provided with an outer heat insulation 28 on its outside.

Via the intermediary of a heat-insulating layer 30, a second mold segment 19, in which a steam chamber 24 is formed, is arranged on the first mold segment 13. The steam chamber 24 can be supplied with superheated steam from a steam generator 26 shown only schematically via a steam feed channel 27, and the superheated steam can be introduced from the steam chamber 24 into the sub-cavity 14 via a plurality of steam channels 18 formed in the first mold segment 13. Shut-off valves or control valves (not shown) may be arranged in the steam channels 18.

A second temperature control system 20, which comprises a plurality of fluid channels 21, which are arranged in the second mold segment 19 and which can be supplied from a source, not shown, with a temperature control fluid, for example, with hot or cold water, as is indicated by the arrow F₂, is associated with the second mold segment 19.

A second temperature sensor 23, which is connected via a line 33 to a second control device 34, which can affect the quantity and the temperature of the temperature control fluid being fed, as is indicated by broken line, is associated with the second mold segment 19. The second mold segment 19 can be brought in this manner to a desired temperature and maintained at this temperature with high accuracy.

The second mold segment 19 is provided with a heat insulation 29 on the outside.

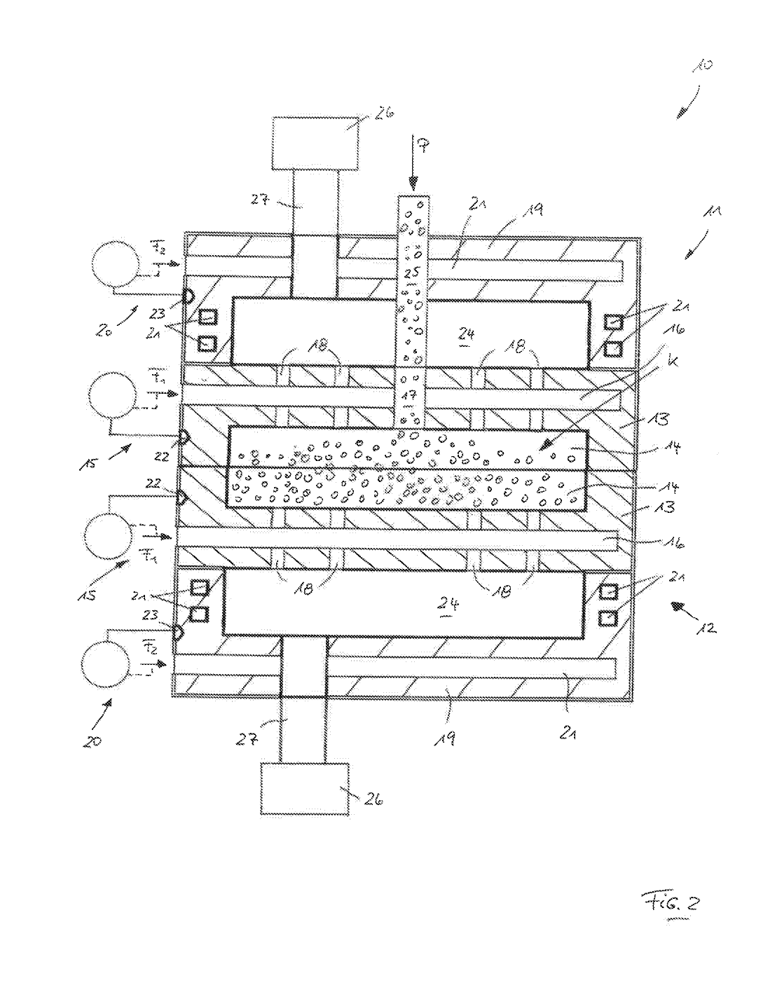

The configuration of the upper, first sub-mold 11 as described so far can correspondingly also be found in the lower, second sub-mold 12, and corresponding components are designated by the corresponding reference numbers. The first sub-mold 11 and the second sub-mold 12 face each other with their sub-cavities 14 and can be brought together, and the sub-cavities 14 form a molding cavity K in the closed state (see FIG. 2).

The upper, first mold segment 11 differs from the lower, second mold segment 12 in the exemplary embodiment shown in that a feed channel 35 for plastic particles is additionally provided. The feed channel 35 comprises a first feed channel section 17, which is formed in the first mold segment 13 and opens in the sub-cavity 14 and passes over at its end facing away from the sub-cavity 14 into a second feed channel section 25, which is formed in the second mold segment 19.

The production cycle for producing a molding composed of a plastic foam shall be described on the basis of FIGS. 2 through 4. The two sub-molds 11 and 12 are first brought together from the state shown in FIG. 1, in which they have been moved apart from one another, wherein the two sub-cavities 14 form the molding cavity K. The two second mold segments 19 of the two sub-molds 11 and 12 are maintained at a predetermined temperature by means of the respective second temperature control system 20, so that the temperature of the wall of the steam chamber 24 is at most 5° C. below the temperature of the superheated steam and preferably corresponds at least to the temperature of the superheated steam and is especially preferably above the temperature of the superheated steam being used by at least 3° C. and especially by about 3° C. to 5° C. Condensation of the superheated steam when it enters the steam chamber 24 is avoided hereby.

The two first mold segments 13 of the two sub-molds 11 and 12 are first heated by means of the respective first temperature control system 15 to a temperature that either corresponds to the temperature of the superheated steam or is slightly above this temperature, as is indicated by the arrow P in FIG. 2.

When the two first mold segments 13 and hence the wall of the molding cavity 14 have reached the temperature level of the superheated steam, the plastic particles are filled into the molding cavity K through the feed channel 35.

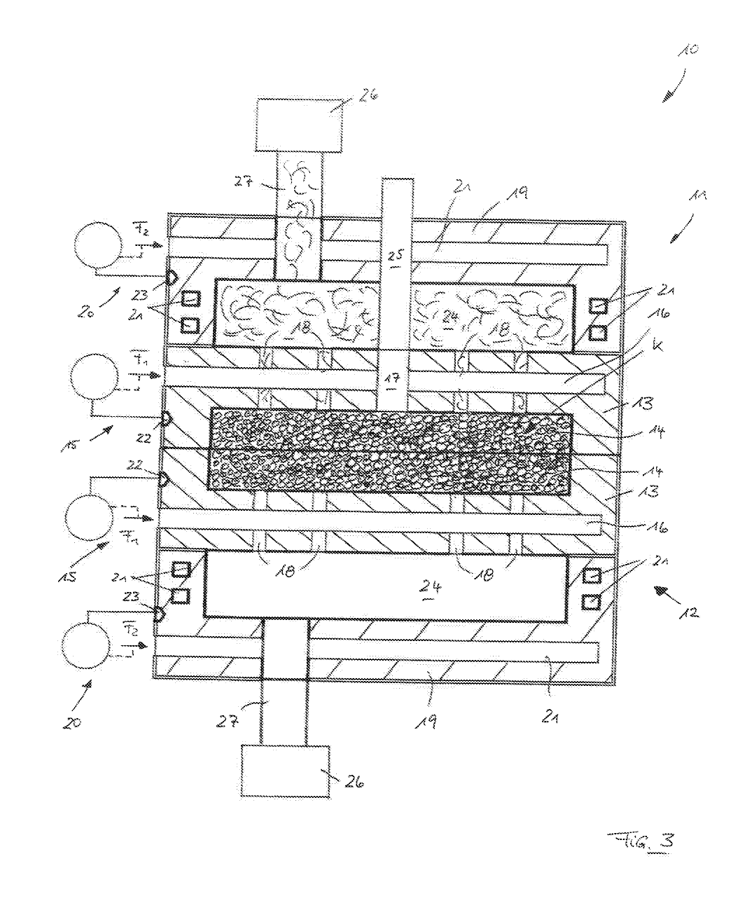

After complete filling of the molding cavity K, the superheated steam is introduced from the steam generators 26 through the respective steam feed channel 27 into the steam chambers 24 and is introduced through the steam channels 18 into the molding cavity K, as it is shown in FIG. 3. Due to the temperature-controlled mold segments, the superheated steam can now reach the molding cavities K without condensation and weld or sinter the plastic particles there.

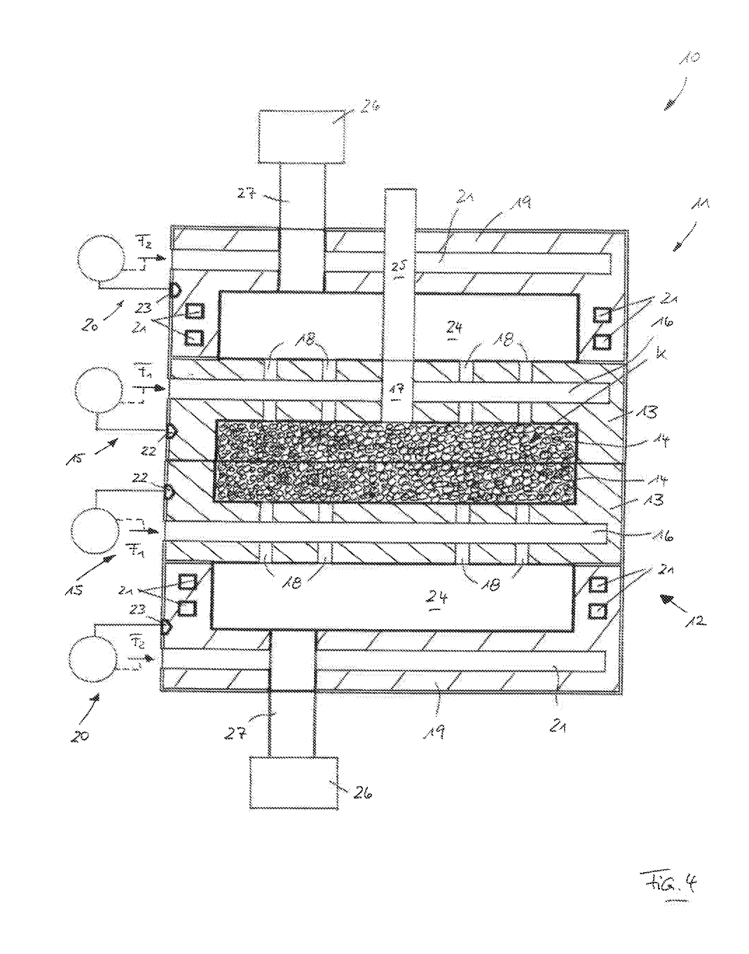

After the welding or sintering of the plastic particles has taken place in the molding cavity K, the feeding of the superheated steam is stopped (see FIG. 4) and the two first mold segments 13 of the two sub-molds 11 and 12 are cooled by the respective first temperature control system 15 to a mold release temperature of, for example, 80° C. (see FIG. 4). After reaching the mold release temperature, the device 10 opens and the stabilized molding can be removed. Consequently, the state shown in FIG. 1 is again reached, and the aforementioned cycle takes place once again starting from this state.

While specific embodiments of the invention have been shown and described in detail to illustrate the application of the principles of the invention, it will be understood that the invention may be embodied otherwise without departing from such principles.

1. A device for producing moldings comprising a particle foam, the device comprising:
a plurality of sub-molds, each of the plurality of sub-molds having a sub-cavity, wherein the sub-cavity of one of the sub-molds and the sub-cavity of another one of the sub-molds are configured to form a molding cavity, wherein at least one of the sub-molds has a feed channel and a steam chamber, wherein a superheated steam from the steam chamber is capable of being introduced into the molding cavity through at least one steam channel and plastic particles are capable of being introduced into the molding cavity through the feed channel, the at least one sub-mold comprising a first mold segment having the sub-cavity and a second mold segment having the steam chamber, wherein the first mold segment has a first temperature control system for one or more of heating and cooling the first mold segment to a predetermined first mold segment temperature, and the second mold segment has a second temperature control system for at one or more of heating and cooling the second mold segment to a predetermined second mold segment temperature.

2. A device in accordance with claim 1, wherein the plurality of sub-molds comprises at least a first sub-mold and a second sub-mold to provide at least two sub-molds, each of the at least two sub-molds comprising the first mold segment and the second mold segment.

3. A device in accordance with claim 1, wherein the first mold segment and the second mold segment are at least one of separated and maintained at spaced locations from one another by a heat-insulating layer.

4. A device in accordance with claim 1, wherein the first temperature control system of the first mold segment has at least one fluid channel, the at least one fluid channel being formed in the first mold segment and a temperature control fluid being capable of flowing through the at least one fluid channel.

5. A device in accordance with claim 1, wherein the first temperature control system has at least one first temperature sensor, the at least one first temperature sensor being connected to a first temperature control device.

6. A device in accordance with claim 1, wherein the second temperature control system of the second mold segment has at least one fluid channel, the at least one fluid channel being formed in the second mold segment and a temperature control fluid being capable of flowing through the at least one fluid channel.

7. A device in accordance with claim 1, wherein the second temperature control system has at least one second temperature sensor, the at least one second temperature sensor being connected to a second temperature control device.

8. A device in accordance with claim 1, wherein the feed channel for the plastic particles has at least one first feed channel section formed in the first mold segment and at least one second feed channel section formed in the second mold segment.

9. A process for producing moldings comprising a particle foam, the process comprising:
providing a device comprising a plurality of sub-molds, each of the plurality of sub-molds having a sub-cavity, wherein the sub-cavity of one of the sub-molds and the sub-cavity of another one of the sub-molds are configured to form a molding cavity, wherein at least one of the sub-molds has a feed channel and a steam chamber, wherein a superheated steam from the steam chamber is capable of being introduced into the molding cavity through at least one steam channel and plastic particles are capable of being introduced into the molding cavity through the feed channel, the at least one sub-mold comprising a first mold segment comprising the sub-cavity and a second mold segment comprising the steam chamber, wherein the first mold segment has a first temperature control system for one or more of heating and cooling the first mold segment, and the second mold segment has a second temperature control system for one or more of heating and cooling the second mold segment, wherein the plastic particles are introduced into the molding cavity and the plastic particles are one or more of formed and sintered 0 in the molding cavity by feeding superheated steam;
maintaining the second mold segment at a second mold segment temperature via the second temperature control system, the second mold segment temperature corresponding to at least a temperature of the superheated steam;
bringing the first mold segment to a first mold segment temperature before or during the feeding of the superheated steam by the first temperature control system, the first mold segment temperature corresponding at least to the temperature of the superheated steam; and
cooling the first mold segment to a mold release temperature by the first temperature control system after the foaming and/or the sintering of the plastic particles in the molding cavity .

10. A process in accordance with claim 9, wherein the second mold segment temperature is above the temperature of the superheated steam by at least 3° C.

11. A process in accordance with claim 9, wherein the plurality of sub-molds comprises at least a first sub-mold and a second sub-mold to provide at least two sub-molds, each of the at least two sub-molds comprising the first mold segment and the second mold segment.

12. A process in accordance with claim 9, wherein the first mold segment and the second mold segment are at least one of separated and maintained at spaced locations from one another by a heat-insulating layer.

13. A process in accordance with claim 9, wherein the first temperature control system of the first mold segment has at least one fluid channel, the at least one fluid channel being formed in the first mold segment and a temperature control fluid being capable of flowing through the at least one fluid channel.

14. A process in accordance with claim 9, wherein the first temperature control system has at least one first temperature sensor, the at least one first temperature sensor being connected to a first temperature control device.

15. A process in accordance with claim 9, wherein the second temperature control system of the second mold segment has at least one fluid channel, the at least one fluid channel being formed in the second mold segment and a temperature control fluid being capable of flowing through the at least one fluid channel.

16. A process in accordance with claim 9, wherein the second temperature control system has at least one second temperature sensor, the at least one second temperature sensor being connected to a second temperature control device.

17. A process in accordance with claim 9, wherein the feed channel for the plastic particles has at least one first feed channel section formed in the first mold segment and at least one second feed channel section formed in the second mold segment.

18. A device in accordance with claim 1, wherein the predetermined second mold segment temperature corresponds to at least a temperature of the superheated steam.

19. A device in accordance with claim 1, wherein the predetermined second mold segment temperature is above a temperature of the superheated steam by at least 3° C.
